(19) United States
(12) Patent Application Publication
(10) Pub. No.: US 2024/0300172 A1
(43) Pub. Date: Sep. 12, 2024

(54) MODULAR PRINTER

(71) Applicant: Divergent Technologies, Inc., Los Angeles, CA (US)

(72) Inventors: Michael Thomas KENWORTHY, Rancho Palos Verdes, CA (US); Seyedalireza Torbatisarraf, Los Angeles, CA (US)

(21) Appl. No.: 18/597,693

(22) Filed: Mar. 6, 2024

Related U.S. Application Data
(60) Provisional application No. 63/450,348, filed on Mar. 6, 2023.

(51) Int. Cl. B29C 64/20; B22F 10/28; B22F 10/31; B22F 12/80; B29C 64/153; B29C 64/393; B33Y 30/00

(52) U.S. Cl. CPC B29C 64/20; B22F 10/31; B22F 12/80; B29C 64/393; B33Y 30/00; B22F 10/28; B29C 64/153

(57) ABSTRACT

The present aspects include an additive manufacturing (AM) system, comprising: a plurality of stations arranged proximate to one another. The plurality of stations includes at least: a first station and a second station; a first AM subsystem configured to dock at the first station and perform a first subsystem AM process; a second AM subsystem configured to dock at the second station and perform a second subsystem AM process; and a third AM subsystem configured to move between the first station and the second station. The AM system further includes a controller configured to control the third AM subsystem to perform an third subsystem AM process at the first station while the first AM subsystem is docked, to move the third AM subsystem from the first station to the second station, and to perform the third subsystem AM process at the second station while the second AM subsystem is docked.

### CROSS REFERENCE TO RELATED APPLICATIONS

This application claims priority to U.S. Provisional Application No. 63/450,348 titled “MODULAR PRINTER” filed Mar. 6, 2023, which is assigned to the assignee hereof, and incorporated by reference in its entirety as if fully set forth herein.

### TECHNICAL FIELD

The present disclosure generally relates to an additive manufacturing and modular printer assembly.

### BACKGROUND

Many current additive manufacturing assemblies utilize singular build stations which perform a particular task or complete a particular build. These build stations therefore encounter large amounts of waste. Specifically, a standard optical bench must fuse a layer of powder and then wait idly while a new layer of powder is added. This process is constantly repeated and therefore creates large amounts of time for which the laser of an optical bench is idle. This causes a lack of efficiency both in terms of time and economically. The standard additive manufacturing system is therefore a bad choice for modern additive laser powder bed fusion printing processes.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to one example, an additive manufacturing (AM) system, comprising: a plurality of stations arranged proximate to one another, including a first station and a second station; a first AM subsystem configured to dock at the first station and perform a first subsystem AM process; a second AM subsystem configured to dock at the second station and perform a second subsystem AM process; a third AM subsystem configured to move between the first station and the second station; and a controller configured to control the third AM subsystem to perform an third subsystem AM process at the first station while the first AM subsystem is docked, to move the third AM subsystem from the first station to the second station, and to perform the third subsystem AM process at the second station while the second AM subsystem is docked.

Another example aspect includes, an AM system wherein the third AM subsystem includes an optical bench, and the AM process includes scanning an energy beam with the optical bench.

Another example aspect includes, an AM system wherein the first AM subsystem includes a first build plate, and the AM process further includes depositing a layer of powder that the energy beam fuses during the scanning.

Another example aspect includes, an AM system wherein the second AM subsystem includes a second build plate.

Another example aspect includes, an AM system wherein the plurality of stations are arranged in a circle or donut shape and wherein each station of the plurality of stations is a wedge shaped station.

Another example aspect includes, an AM system wherein the third AM subsystem is configured to move between the first station and the second station using at least one of a robotic automated guided vehicle, a rail-based system, a floor conveyer, or a gantry.

Another example aspect includes, an AM system further including a fourth station configured to calibrate or set up or calibrate at least one of the first subsystem, the second subsystem or the third subsystem.

Another example aspect includes, an AM system wherein setting up at least one of the first subsystem, the second subsystem or the third subsystem includes pairing the subsystem with utilities such as inert gas, power, reserve powder or calibration of an optical bench.

Another example aspect includes, a modular printer system, comprising: a movable base member having a plurality of dividing walls that define therebetween a plurality of movable modules, wherein each module of the plurality of modules includes a powder bed and an optical bench; a plurality of stationary build chambers; a plurality of stationary depowdering chambers; and a controller configured to move the moveable base member and in turn the plurality of modules between the plurality of stationary build chambers and the plurality of stationary depowdering chambers.

Another example aspect includes, a modular printer system, wherein each build chamber of the plurality of build chambers may be located adjacent to a corresponding depowdering chamber of the plurality of depowdering chambers.

Another example aspect includes, a modular printer system, wherein the controller sends instructions to the movable base member to move such that each module of the plurality of modules moves between the plurality of build chambers and the plurality of depowdering chambers.

Another example aspect includes, a modular printer system, further comprising a centralized powder overflow tank configured to receive the excess powder from each of the respective stationary depowdering chambers including a centralized powder recycling system which filters and recycles the excess powder from each of the respective stationary depowdering for later use.

Another example aspect includes, a modular printer system, further comprising a centralized powder reservoir configured to feed powder to each of the plurality of stationary build chambers.

Another example aspect includes, a modular printer system, further comprising a centralized vacuum system configured to removably attach to each movable module

Another example aspect includes, a modular printer system, further comprising at least one centralized laser configured to be reflected to each corresponding optical bench to be utilized by the plurality of stationary build chambers.

Another example aspect includes, a modular printer system, comprising: a plurality of stationary modules arranged adjacent to one another, wherein each module of the plurality of modules includes a powder bed and an optical bench; a plurality of movable build chambers; a plurality of movable depowdering chambers; and a controller configured to synchronize the movement of the plurality of moveable build chambers and the plurality of moveable depowdering chambers between the plurality of stationary modules.

Another example aspect includes, a modular printer system, wherein each moveable build chamber of the plurality of build chambers may be located adjacent to a corresponding moveable depowdering chamber of the plurality of depowdering chambers.

Another example aspect includes, a modular printer system, wherein the controller sends instructions to the plurality of moveable build chambers and the plurality of moveable depowdering chambers such that each moveable build chamber of the plurality of build chambers and each moveable depowdering chamber of the plurality of depowdering chambers moves from one stationary module of the plurality of stationary modules to an adjacent stationary module in a synchronized manner.

Another example aspect includes, a modular printer system, further comprising a centralized powder overflow tank configured to receive the excess powder from each of the respective moveable depowdering chambers including a centralized powder recycling system which filters and recycles the excess powder from each of the respective moveable depowdering chambers for later use.

Another example aspect includes, a modular printer system, further comprising a centralized powder reservoir configured to feed powder to each of the plurality of moveable build chambers.

Another example aspect includes, a modular printer system, further comprising a centralized vacuum system configured to removably attach to each stationary module.

Another example aspect includes, a modular printer system, further comprising at least one centralized laser configured to be reflected to each corresponding optical bench to be utilized by the plurality of moveable build chambers.

### BRIEF DESCRIPTION OF THE DRAWINGS

FIG. 1 is a top view of an exemplary additive manufacturing system.

FIG. 2 is a top view of an exemplary additive manufacturing system with multiple movable subsystems.

FIG. 3 is a top-front view of an exemplary additive manufacturing system.

FIG. 4 is a top view of an exemplary carousel style additive manufacturing system.

### DETAILED DESCRIPTION

Various aspects of the disclosure are now described with reference to the drawings, wherein like reference numerals are used to refer to elements throughout. In the following description, for purposes of explanation, numerous specific details are set forth in order to promote a thorough understanding of one or more aspects of the disclosure. It may be evident in some or all instances, however, that any aspects described below can be practiced without adopting the specific design details described below.

An additive manufacturing system, which utilizes a modular printing assembly serves to increase the efficiency of standard additive manufacturing processes. The additive manufacturing system described herein utilizes a plurality of stations and subsystems configured to be configurable and customizable to create the most efficient method of performing a series of builds.

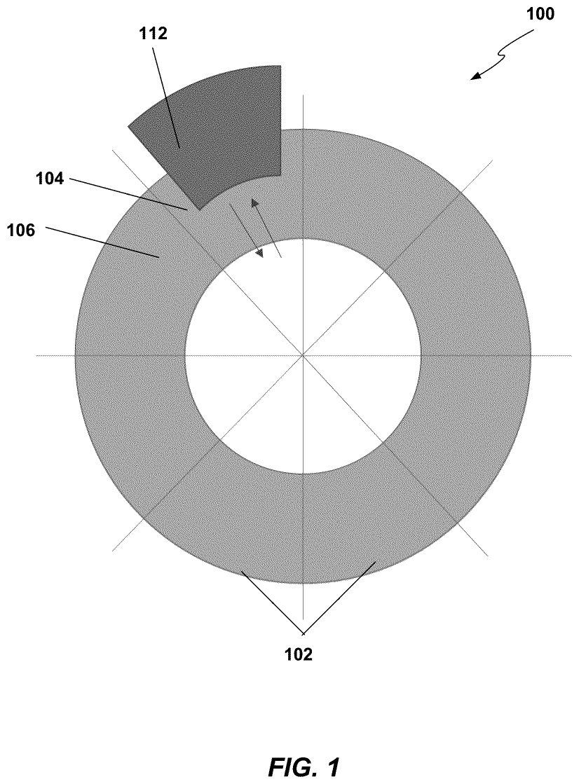

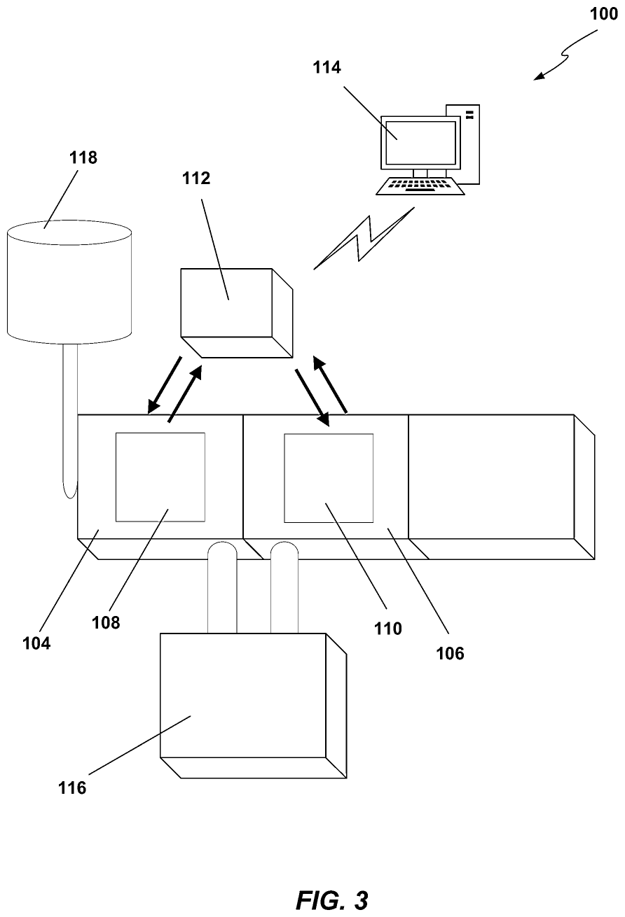

Referring to FIGS. 1-3, according to one example, an additive manufacturing system 100 includes a plurality of stations 102 arranged proximate to one another. FIG. 1 exemplifies an additive manufacturing system 100 which includes eight stations that are arranged in a circular configuration, and wherein each station of the plurality of stations 102 is wedge shaped. This configuration is merely to exemplify the overall concept, and it should be noted that a plurality of different configurations may be utilized, for example the stations may be arranged in a square shape with each station also being a square shape or a hexagon shape, wherein each station is a trapezoid shape . . . etc. Numerous different configurations may be utilized in the present additive manufacturing system 100.

The additive manufacturing system 100 includes a plurality of stations 102, as described above, which further include at least a first station 104 and a second station 106. The additive manufacturing system 100 further includes a plurality of subsystems, which includes at least a first subsystem 108 and a second subsystem 110. The first subsystem 108 and the second subsystem 110 may be a first build plate and a second build plate respectively. The first subsystem 108 may be configured to dock at the first station 104 and the and second subsystem 110 may be configured to dock at the second station 106, however any subsystem of the plurality of subsystems may dock at any station of the plurality of stations that is open, and not currently occupied by a different subsystem.

The additive manufacturing system 100 now includes a first station 104 with a first subsystem 108 docked at it and a second station 106 with a second subsystem 110 docked at it. Further the first subsystem 108 is a first build plate and the second subsystem 110 is a second build plate. The additive manufacturing system 100 further includes a third subsystem 112 that is configured to be movable between the first station 104 and the second station 106. The third subsystem 112 in the additive manufacturing system 100 may include an optical bench. The additive manufacturing system 100 therefore includes a first build plate at the first station 104 and a second build plate at the second station 106, and an optical bench configured to be movable between the first and second build plate.

The additive manufacturing system 100 further includes a controller 114. The controller 114 is configured to determine which subsystems of the plurality of subsystems may dock at which stations of the plurality of stations 102. The controller may further control the movement of the third subsystem between the first station 104 and the second station 106. The controller 114 may utilize a number of different factors, which are discussed in more detail below, to determine the movements of the third subsystem, as well as when different subsystems may dock at a particular station.

The first subsystem 108 is configured to perform a first subsystem additive manufacturing (AM) process while docked at the first station 104. The first subsystem 108 in the current configuration is a first build plate, and therefore the first subsystem AM process may be to deposit a layer of powder onto the build plate. Once the first subsystem AM process has been completed by the first subsystem 108, or in other words, once the layer of powder has been deposited onto the first build plate, the controller 114 is configured to move the third subsystem 112 to the first station 104. Therefore, once the layer of powder has been deposited onto the first build plate the controller 114 is configured to move the optical bench to the first build plate with the layer of powder deposited onto it. The controller 114 then instructs the third subsystem 112 to complete a third subsystem AM process at the first station 104. The third subsystem AM process may include scanning an energy beam with the optical bench to fuse the powder.

During the third subsystem AM process, or during the scanning and fusing process being performed by the optical bench at the first station 104, the controller 114 is simultaneously instructing the second subsystem 108 to perform a second subsystem AM process at the second station. Similar to the first subsystem the second subsystem AM process may be depositing a layer of powder onto the second build plate. Therefore while the optical bench is fusing the first layer of powder at the first build plate a second layer of powder is being deposited onto the second build plate at the second station 106. Once the third subsystem AM process has been completed and the second subsystem AM process has been completed, or in other words, once the first layer of powder has been fused at the first station 104, and the second layer of powder has been deposited onto the second build plate at the second station 106, then the controller 114 instructs the third subsystem to move from the first station 104 to the second station 106 (i.e. the optical bench moves from the first build plate to the second build plate). The controller 114 may then instruct the third subsystem 112 to once again perform the third subsystem AM process at the second station 106. While the third subsystem AM process is being performed at the second station 106 the controller once again instructs the first subsystem 108 to repeat the first subsystem AM process. Therefore while the second layer of powder is being fused at the second build plate utilizing the optical bench the a new layer of powder is being deposited onto the first build plate at the first station 104.

This series of steps may be repeated as long as necessary to complete the builds at each respective station. Therefore the controller 114 will instruct the third subsystem 112 to move between the first station 104 and second station 106 to perform the laser scanning process as the previous station deposits a new layer of powder. Upon completion of a part at one of the plurality of stations 102, the controller may instruct the subsystem docked at that station to undock to be replaced by a new subsystem. In other words once a part has been completed by a build plate, the build plate may undock from its station and be replaced by a new build plate. The third subsystem 112, or optical bench, may now begin fusing powder on the new build plate.

This process is advantageous as this allows the laser of the optical bench to keep being used without having to stop as a new layer of powder is deposited each time. In the AM assembly described above, the optical bench can move between multiple build plates so as one build plate is depositing a new layer of powder the optical bench can move to and be used at a different build plate that has a layer of powder already deposited and then the optical bench can once again move to the original build plate which will now have a new layer of powder and so on.

The third AM subsystem 112 may be moveable from one station to another through a number of different methods including, but not limited to: a robotic automated guided vehicle (AGV), a rail-based system, a floor conveyer, a gantry, or any other similar movement mechanism. Further the third AM subsystem may be moveable between more than just a first station and a second station. The third AM subsystem or optical bench may be movable between any number of different stations or build plates. For example a different AM system configuration may have three subsystems that include build plates, and a fourth subsystem that includes and optical bench, and the fourth subsystem moves between a first station with a first build plate, a second station with a second build plate, and a third station with a third build plate. The controller would then instruct the fourth subsystem to move between the three stations.

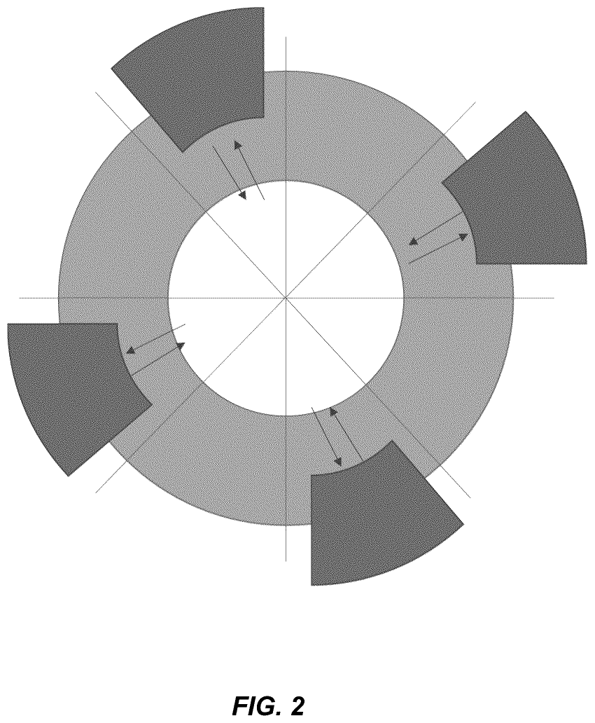

In a further alternative embodiment, as is the case in FIG. 2, there may be eight stations each with a subsystem dockable at that station, and may further include four additional (or any number as necessary for a particular application) subsystems, which may be configurable to move between the stations. In one example implementation of FIG. 2, the moveable subsystems (i.e. the optical benches) may be moveable back and forth between two stations and therefore two build plates, while an a different example implementation each of the optical benches or moveable subsystems may move between all eight stations, and therefore all eight build plates. In this configuration each of the four optical benches would be at a build plate and each laser would be functioning to fuse powder at the build plate, while at the same time each of the four build plates that does not have an optical bench at it is depositing a new layer of powder. Each of the optical benches may then move one station over and fuse the new layers of powder as the previous stations and build plates deposit a new layer of powder. The optical benches may then shift over again and this process may be repeated as long as necessary.

In an additional example implementation the additive manufacturing system 100 may have an additional station in the plurality of stations that may set-up or calibrate each of the subsystems of the plurality of subsystems. For example, referring to FIG. 2, one of the eight stations may include a station utilized for mating assembly to various required utilities such as inert gas, powder, power, etc. or for the calibration of optical benches. Therefore in one example implementation, one of the stations may be used to set up a build plate with inert gas, power, powder and any other utilities, which may be needed. Alternatively the station could be utilized to calibrate the or one of the optical benches. Further additional depowdering stations may be implemented as well. After completion of a build one of the subsystems may undock and move to a depowdering station where the depowdering process may occur.

In an additional aspect, the additive manufacturing system 100 may include a plurality of shared systems. One shared system which may be utilized by the additive manufacturing system 100 is a centralized powder overflow tank 116 configured to receive the excess powder from each of the respective stations and may further include a centralized powder recycling system which filters and recycles the excess powder from each of the respective stations for later use. Additionally the system 100 may include a centralized powder reservoir 118 configured to feed powder to each of the plurality of build plates at the plurality of stations.

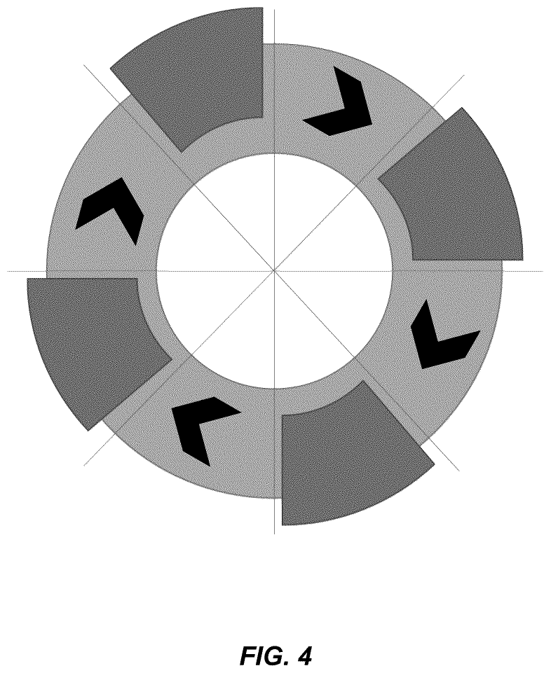

In a further alternative example, as shown in FIG. 4, the each of the plurality of stations may be movable in a carousel style configuration while each of the previously movable subsystems (i.e. the optical benches) would be stationary. In other words the build plates would move underneath the stationary optical benches as needed. In this example there would be a plurality of stations 102 and a plurality of subsystems 120. In the configuration shown in FIG. 4, there is a stationary subsystem at every other station. In this example configuration a first station 102, including a first build plate, would receive a layer of powder, the carousel would then shift so the first station would be located under one of the plurality of subsystems 120 including an optical bench where a laser would fuse the powder. At the same time a second station 106 would then move out from under one of the plurality of subsystems 120 and would receive a new layer of powder. The carousel would the shift again and the first station would receive another layer of powder while the new layer of powder on the second station is fused by one of the plurality of subsystems. The carousel may rotate constantly in a single direction a shown in FIG. 4. In this configuration a single station would move from one of the plurality of subsystems to an open location where a new layer of powder is applied and then it would rotate again to a different one of the plurality of subsystems where the new layer of powder would then be fused. Alternatively instead of continuously rotating in one direction the carousel could shift back and forth so each station would move in and out of the same subsystem of the plurality of subsystems.

Each of the configurations discussed above focuses on maintaining high efficiency during the additive manufacturing process. In any of the described configurations the focus is to reduce the idle time of the optical bench, and the laser specifically, so that power is not wasted turning the laser on and off constantly. In each of the described embodiments an optical bench will quickly move from one build plate to the next while a different build plate may receive a new layer of powder so that the optical bench can then move to that one without having to wait for the powder to be continuously added after each layer.

In general, the description of the aspects disclosed should be considered as being illustrative in all respects and not being restrictive. The scope of the present disclosure is shown by the claims rather than by the above description, and is intended to include meanings equivalent to the claims and all changes in the scope. While preferred aspects of the disclosure have been described above, it is to be understood that variations and modifications will be apparent to those skilled in the art without departing from the scope and spirit of the disclosure.

1. An additive manufacturing (AM) system, comprising:
a plurality of stations arranged proximate to one another, including a first station and a second station;
a first AM subsystem configured to dock at the first station and perform a first subsystem AM process;
a second AM subsystem configured to dock at the second station and perform a second subsystem AM process;
a third AM subsystem configured to move between the first station and the second station; and
a controller configured to control the third AM subsystem to perform an third subsystem AM process at the first station while the first AM subsystem is docked, to move the third AM subsystem from the first station to the second station, and to perform the third subsystem AM process at the second station while the second AM subsystem is docked.

2. The AM system of claim 1, wherein the third AM subsystem includes an optical bench, and the AM process includes scanning an energy beam with the optical bench.

3. The AM system of claim 2, wherein the first AM subsystem includes a first build plate, and the AM process further includes depositing a layer of powder that the energy beam fuses during the scanning.

4. The AM system of claim 3, wherein the second AM subsystem includes a second build plate.

5. The AM system of claim 1, wherein the plurality of stations are arranged in a circle or donut shape and wherein each station of the plurality of stations is a wedge shaped station.

6. The AM system of claim 1, wherein the third AM subsystem is configured to move between the first station and the second station using at least one of a robotic automated guided vehicle, a rail-based system, a floor conveyer, or a gantry.

7. The AM system of claim 1, further including a fourth station configured to calibrate or set up or calibrate at least one of the first subsystem, the second subsystem or the third subsystem.

8. The AM system of claim 7, wherein setting up at least one of the first subsystem, the second subsystem or the third subsystem includes pairing the subsystem with utilities such as inert gas, power, reserve powder or calibration of an optical bench.

9. A modular printer system, comprising:
a movable base member having a plurality of dividing walls that define therebetween a plurality of movable modules, wherein each module of the plurality of modules includes a powder bed and an optical bench;
a plurality of stationary build chambers;
a plurality of stationary depowdering chambers; and
a controller configured to move the moveable base member and in turn the plurality of modules between the plurality of stationary build chambers and the plurality of stationary depowdering chambers.

10. The modular printer assembly of claim 9, wherein each build chamber of the plurality of build chambers may be located adjacent to a corresponding depowdering chamber of the plurality of depowdering chambers.

11. The modular printer assembly of claim 10, wherein the controller sends instructions to the movable base member to move such that each module of the plurality of modules moves between the plurality of build chambers and the plurality of depowdering chambers.

12. The modular printer assembly of claim 9, further comprising a centralized powder overflow tank configured to receive the excess powder from each of the respective stationary depowdering chambers including a centralized powder recycling system which filters and recycles the excess powder from each of the respective stationary depowdering for later use.

13. The modular printer assembly of claim 9, further comprising a centralized powder reservoir configured to feed powder to each of the plurality of stationary build chambers.

14. The modular printer assembly of claim 9, further comprising a centralized vacuum system configured to removably attach to each movable module.

15. The modular printer assembly of claim 9, further comprising at least one centralized laser configured to be reflected to each corresponding optical bench to be utilized by the plurality of stationary build chambers.

16. A modular printer system, comprising:
a plurality of stationary modules arranged adjacent to one another, wherein each module of the plurality of modules includes a powder bed and an optical bench;
a plurality of movable build chambers;
a plurality of movable depowdering chambers; and
a controller configured to synchronize the movement of the plurality of moveable build chambers and the plurality of moveable depowdering chambers between the plurality of stationary modules.

17. The modular printer assembly of claim 16, wherein each moveable build chamber of the plurality of build chambers may be located adjacent to a corresponding moveable depowdering chamber of the plurality of depowdering chambers.

18. The modular printer assembly of claim 17, wherein the controller sends instructions to the plurality of moveable build chambers and the plurality of moveable depowdering chambers such that each moveable build chamber of the plurality of build chambers and each moveable depowdering chamber of the plurality of depowdering chambers moves from one stationary module of the plurality of stationary modules to an adjacent stationary module in a synchronized manner.

19. The modular printer assembly of claim 16, further comprising a centralized powder overflow tank configured to receive the excess powder from each of the respective moveable depowdering chambers including a centralized powder recycling system which filters and recycles the excess powder from each of the respective moveable depowdering chambers for later use.

20. The modular printer assembly of claim 16, further comprising a centralized powder reservoir configured to feed powder to each of the plurality of moveable build chambers.

21. The modular printer assembly of claim 16, further comprising a centralized vacuum system configured to removably attach to each stationary module.

22. The modular printer assembly of claim 16, further comprising at least one centralized laser configured to be reflected to each corresponding optical bench to be utilized by the plurality of moveable build chambers.
